(19) United States
(12) Patent Application Publication
(10) Pub. No.: US 2009/0128615 A1
(43) Pub. Date: May 21, 2009

(54) Printing system

(76) Inventor: David Miller, Cheshire (GB)

Correspondence Address: SALIWANCHIK LLOYD & SALIWANCHIK;A PROFESSIONAL ASSOCIATION, PO Box 142950, GAINESVILLE, FL, 32614, US

(21) Appl. No.: 11/911,360

(22) PCT Filed: Apr. 25, 2006
(86) PCT No.: PCT/GB06/01489

§ 371 Date: Jun. 23, 2008

(30) Foreign Application Priority Data
Apr. 25, 2005 (GB) 0508360.5

(51) Int. Cl. B41J 2/47

(52) U.S. Cl. 347/232

(57) ABSTRACT

A substrate-marking system comprises a substrate-marking apparatus and a substrate which is susceptible, or includes an additive which is susceptible, to changing colour upon irradiation. The apparatus comprises a laser diode for emitting a beam of laser light and a galvanometer for aligning a desired point on the substrate with the laser beam such that the laser beam irradiates the desired point thus causing the additive, in use, to change colour at the point.

### FIELD OF THE INVENTION

This invention relates to a method of printing and a system therefor.

### BACKGROUND TO THE INVENTION

Lasers have been widely used to achieve marking, typically by ablation but also by causing material, that can absorb laser energy, to char or change colour. A coating layer is typically formed on a substrate to be marked. The coating layer contains an additive that is darkenable under the action of a CO₂ laser beam. CO₂ lasers have typically been used for this purpose due to their long operating lives, at least 10,000 operating hours. The coating is darkenable upon irradiation with focused energy of the laser source.

Known laser marking techniques have the disadvantage that the apparatus used are relatively large, expensive, inefficient and are capable of limited marking speeds and resolution. They further have the disadvantage that only monochrome printing is achievable whereas full colour printing is highly desirable for many applications.

### SUMMARY OF THE INVENTION

In accordance with a first aspect, the present invention is a substrate-marking system comprising a substrate-marking apparatus and a substrate which is susceptible, or includes an additive which is susceptible, to changing colour upon irradiation, the apparatus comprises a laser diode for emitting a beam of laser light and a galvanometer for aligning a desired point on the substrate with the laser beam such that the laser beam irradiates the desired point thus causing the additive, in use, to change colour at said point.

The system of the present invention enables substrate marking by a laser diode to effect monochrome or multi-colour printing. The system is suitable for high speed industrial application to which end the laser source has a long operating life, is efficient, reliable, readily controllable, and is capable of high speed or high resolution printing. In the case of high resolution printing, molecular resolution is envisaged. The system is also capable of printing on a wide variety of substrates in a cost efficient manner.

In accordance with a second aspect, the present invention is a method of substrate marking using the substrate-marking system in accordance with the first aspect of the present invention, the method comprising the steps of controlling the galvanometer to align a desired point on the substrate with the laser beam emitted by the laser diode, and irradiating the desired point with the laser beam to cause the substrate, or additive, to change colour at said point.

### DESCRIPTION OF THE INVENTION

The substrate-marking system in accordance with the first aspect of the present invention may be used with a wide variety of substrate materials, for example, metals, alloys, glasses, ceramics, plastics, fabrics, wood, paper, card, resins, rubbers, foams, composites, stone and edibles, although virtually any material may be suitable. The substrates themselves may be adapted to change colour upon irradiation with the laser, or the substrates may be provided with an additive susceptible to changing colour upon irradiation with the laser. Where provided, the colour change additive is preferably in a composition, or matrix, which may be applied in the form of a liquid as a coating on the substrate. It is highly desirable that the composition containing the additive be transparent, or at least translucent, and colourless so that the composition may be covertly applied or used for printing on transparencies for use with overhead projectors and the like. It is further desirable that the additive be non-toxic so that the composition may be ingested, for example, where the substrate is a pill or a fruit. The additive may alternatively be provided within the substrate itself, where the substrate allows, for example, where the substrate is made of plastics material then the additive may be incorporated into the substrate during manufacture of the substrate. Alternatively, where the substrate is made of fabric material, the additive, or composition containing the additive, may be applied in liquid form to the fabric and absorbed therein. In a yet further example, the additive may be applied between two layers of a substrate thus sandwiching the additive, or a composition containing the additive, therebetween. Various other examples for incorporating the additive on or in the substrate will be apparent from the following description or will be readily appreciated by those skilled in the art.

In developing suitable additives for use in the system of the present invention, the inventors sought additives which are susceptible to changing colour under low fluence levels. The term fluence refers to the total amount of energy applied by the laser beam per unit area of the substrate. It is clearly desirable, to increase the energy efficiency of the system and the speed at which the system may operate, to provide an additive or additives which are susceptible to changing colour at low fluence levels. As described above, CO₂ lasers, and to some extent YAG lasers, have been used previously due to the high fluence levels required by current laser printing techniques. Prior art printing techniques require fluence levels of the order of 1 J/cm² for around 10 seconds to achieve marking by burning or ablation.

By providing additives susceptible to changing colour under low fluence levels the present inventors have utilized a highly efficient laser diode as the laser light source, rather than a conventional CO₂ or YAG laser. Fluence levels of less than 500 mJ/cm² are preferably provided by the laser beam. Until now, laser diodes have not been considered suitable laser sources for substrate-marking systems, mainly due to their low power and poor beam quality. However, laser diodes have many advantages over conventional CO₂ lasers. Conventional CO₂ lasers may be pulsed such that the laser output consists of a series of intense energy pulses. These energy pulses are typically pumped at a frequency of approximately 4.5 kHz but frequencies in the range of 20-30 kHz are achievable. Due to the lead in and lead out time of each pulse, the frequency at which conventional CO₂ lasers can be pumped is limited to prevent the pulses from overlapping thus forming a, so called, continuous wave output. Laser diodes have the distinct advantage in that the semiconductor therein may be switched virtually instantaneously and so laser diodes can be operated well into the MHz region. High switching speeds are particularly desirable in substrate-marking systems to increase the speed of the system. In addition, the lack of overlap between successive pulses greatly improves the potential control of each laser pulse. Typical laser diodes can currently be switched in approximately 100 nanoseconds, although this is likely to decrease in the future.

Laser diodes further have the advantage in that they are relatively cheap and their cost is decreasing by approximately 20% year on year. Infrared and near infrared laser diodes are readily utilized in the telecommunications industry for their low cost. Laser diodes operating in the UV spectrum are significantly more expensive at present, but again their cost is decreasing year on year. In general, the lower the wavelength of the laser light the smaller the spot size that can be created and so UV diodes are particularly suitable for the type of very high resolution printing enabled by the present invention.

Laser diodes can have a problem, however, in that they have a relatively high beam divergence and poor beam quality. For low resolution printing this drawback, when compared with CO₂ lasers, is not necessarily a prohibitive problem. However, for the very high resolution printing envisaged for the present invention it is preferable that the substrate-marking system further comprises means for shaping the laser beam. In a preferred example, the laser beam is shaped by coupling a fibre optic cable to the laser diode for homogenizing the laser beam. Further preferably, collimating and/or objective lenses are provided between the laser diode and the substrate. These may be provided in any suitable number and may be disposed before or after the galvanometer for aligning the laser beam with the substrate. The resolution of the printing may be altered by providing a movable objective lens which may be moved to alter the focal length, and therefore the spot size, of the laser beam lasing the substrate. A motorized zoom lens is provided as a suitable example.

The galvanometer may either comprise a pair of mirrors for scanning in the X and Y directions, respectively, or the galvanometer may comprise a single mirror for scanning in a single axis (i.e. X or Y). In the case of a dual galvanometer system (i.e. having two mirrors), the substrate-marking apparatus, including the laser diode and the dual galvanometer system, is spatially fixed relative to the substrate to be marked. In the case of a single galvanometer system (i.e. having one mirror), the substrate-marking apparatus, including the laser diode and the galvanometer, and the substrate are moved relative to one another along an axis substantially perpendicular to the scanning axis of the galvanometer mirror. Either of these galvanometer systems are suitable in the substrate-marking system of the present invention. The galvanometer may be driven by a control system operating in a vectoring or progressive scan mode. In a vectoring mode, the laser beam follows only the areas of the substrate to be marked. In a progressive scan mode, the laser beam tracks the substrate in successive lines, marking the substrate where necessary. Instead of the single mirror galvanometer described above, a rotating polygon of known type may be used as a cheaper, higher speed alternative for progressive scanning.

Where the substrate-marking system in accordance with the present invention operates in scanning mode for scanning the laser beam over a surface of the substrate, the laser diode may be pulsed at approximately 25 nanoseconds pulses. Pulse duration of between approximately 10 nanoseconds and 50 nanoseconds is envisaged to be suitable for use with the colour change additives to which the system and method of the present invention are specifically intended, although other pulse durations may be equally suitable depending on the additive, the maximum power output of the laser diode, the intended speed of operation of the substrate-marking system of the present invention, or the intended printing resolution. The laser diode may alternatively have a continuous wave output and the beam emitted therefrom may be gated. Lower power laser diode sources necessarily require longer pulse durations.

The additive included in or on the substrate may be adapted to change colour to one of at least two selectable colours upon irradiation with the laser light according to a fluence level of the laser beam at the point under irradiation. Since the fluence level is a measure of the total amount of energy applied per unit area, the colour change which the additive undergoes at the desired point is a function of the laser beam power, the area of the substrate under irradiation and the dwell time of the laser beam at that power on that area. Accordingly, it becomes possible to select the resultant colour of the additive at the desired point as a result of the irradiation by the laser beam according to a number of different factors.

In one example, the substrate-marking system may be controlled such that the laser beam spot size on the substrate is substantially constant throughout the marking operation. In addition, the marking speed is also substantially constant such that the dwell time of the laser beam directed towards a desired point on the substrate having an area equivalent to the spot size of the laser beam is substantially constant for each similar desired point on the substrate. In this manner, the colour change of the additive may be effected by modulating the power output of the laser beam irradiating the desired point for the dwell time by a suitable laser beam power level modulating means. Alternatively, during the fixed dwell time, a different number of pulses may be controlled, or the pulse duration at a constant power during the dwell time may be controlled to effect the colour change. This mode of operation is particularly suitable for bitmap imaging whereby an image to be formed on the substrate is converted into a bitmap image comprising a matrix of pixels which, by the system of the present invention, is produced on the substrate. The pixel resolution of this image may be readily altered by changing the focus spot size of the laser beam. This may be effected by moving the movable objective lens. The switching between high laser power and low laser power may be effected almost instantaneously between successive pulses of the laser to cause the additive to change colour differently for each subsequent pixel in the pulsing sequence. Where it is desired that no colour change of the additive is required for a plurality of adjacent pixels then the system may be configured to jump from one area of the substrate to another area of the substrate to improve the marking speed.

In another preferred example of the present invention the laser diode may be controlled so as to operate in a binary fashion between an off state between pulses and an on state at a preselected power level for each pulse. By coupling this control to the galvanometer, the dwell time of each pulse at each desired point on the substrate may be controlled to select the desired resultant colour at said point. Under this mode of operation, the scanning speed will be non-uniform in the creation of a greyscale monochrome or multi-colour image on the substrate. Stepper motors may be utilized for driving a substrate table or conveyor upon which the substrate is mounted where only a single axis galvanometer is provided.

In yet another preferred example of the present invention, the power level of the laser beam may be modulated according to both the desired colour change of the additive to be effected at each point and also according to the spot size for a constant scanning speed. In this manner, both high resolution and low resolution printing may be effected in different regions of the substrate during a single printing operation.

A control means for controlling the galvanometer, and for controlling the fluence level of the laser beam may be a single control means or a plurality of co-operating control means. The control means is preferably a computer control means which uses a look up table containing such variables as the substrate material, the additive material, the concentration of the additive material in the substrate, the laser power from a feedback device, a position of the objective lens for controlling the spot size of the laser beam and the desired colour to be achieved at each point on the substrate to ensure correct reproduction of the desired image on the substrate.

In any of the above described examples of the present invention where the laser diode is coupled to a fibre optic cable, the end of the fibre cable furthest from the laser diode may be shaped so as to function as a lens to focus the emergent laser beam.

In a yet further example of the present invention, the laser diode may be aligned with desired points on the substrate in a vectoring format rather than a progressive scan format. In this mode of operation, only desired points in the substrate where colour change is to be effected are irradiated with the laser beam. Preferably, the laser beam is switched in a binary fashion between an off mode and an on mode at a preselected power level for printing a single colour on the substrate. Subsequently, the power level of the laser diode in the on mode is set to a second predetermined power level for printing a second colour on the substrate. This sequence may be repeated as required to achieve the desired number of shades and/or colours to be imagewise printed on the substrate from the number of selectable colours achievable from the substrate and additive combination under irradiation.

Preferably, the additive is a thermally sensitive additive which changes colour upon application of thermal energy by the laser beam. The additive may include a charge-delocalising compound and a photoacid, the photoacid, in use, generating an acid upon irradiation by the laser thereby forming a charge transfer complex with the compound. The charge-delocalised compound may include a heteroatom selected from N, O and S, and an aromatic group conjugated thereto. The charge-delocalising compound may be an amine, for example carbozole.

Alternatively, the additive may be susceptible to colour change from application of light energy in the form of laser light. With this type of additive the laser energy is not converted into heat but instead it is thought that a quantisation effect is responsible for polymerising the additive to give a colour dependent upon the conjugation length. One example of such an additive is diacetylene which may further be combined with a photoacid or photobase for tuning the quantisation effect to particular wavelengths corresponding to commercially available laser diodes. This is particularly advantageous since it becomes possible to tune the additive to relatively cheap laser diodes. The above exemplary additive is particularly suitable for multi-colour printing by a tunable UV laser diode.

Whilst vector format imaging may be advantageous where only limited areas of the substrate are to be imagewise marked, where an image is to be produced over the entire substrate area, bitmap imaging is equally fast and bitmap imaging is more commercially acceptable and so bitmap imaging is the preferred mode of operation.

It is preferable that the additive be readily formulated in a solvent or water based ink as a coating composition which may be applied to any suitable substrate. One particularly commercially important example of the present invention is a substrate-marking system in which the substrate is paper and the additive is coated as a liquid thereon and subsequently cured such that the substrate having the additive may be marked by the substrate-marking apparatus functioning as a desktop printer. In such an example, the only consumables will be the electricity required for the substrate-marking apparatus and the coated paper. There will then be no requirement for replenishing liquid ink or toner in the printing system.

### BRIEF DESCRIPTION OF THE DRAWINGS

FIG. 1 is a flow diagram illustrating the interaction between aspects of the substrate-marking system of the present invention;

FIG. 2 is a schematic view of the galvanometer for the system of the present invention; and,

FIG. 3 is a schematic view of an alternative galvanometer for the system of the present invention.

### DETAILED DESCRIPTION

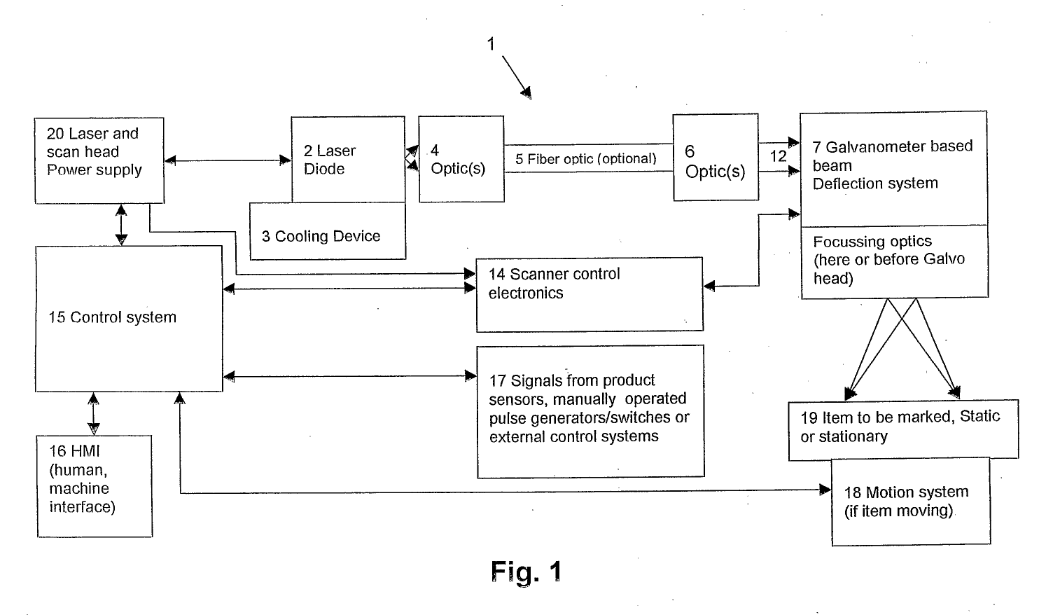

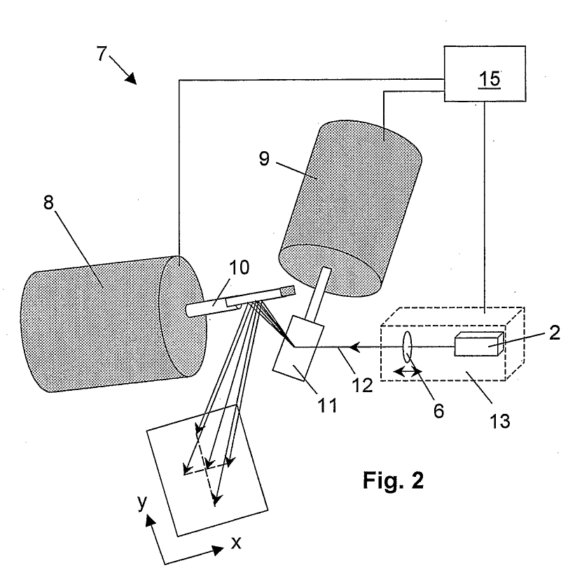

FIG. 1 shows a block diagram of an exemplary embodiment of the system of the present invention. The substrate marking system 1 comprises a laser diode 2 which may be cooled by a cooling device 3. The laser diode 2 outputs a beam of laser light which is transferred through a first optical system 4 and into an optical fibre 5 for homogenizing the laser beam. Upon exiting the optical fibre 5, the beam enters a further optical system 6 which may typically include a collimating lens and/or an objective lens. The laser beam then enters a galvanometer beam deflection system 7 such as that shown in detail in FIG. 2. The galvanometer beam deflection system 7 comprises an X direction galvanometer 8 and a Y direction galvanometer 9. The X and Y direction galvanometers 8, 9 have respective mirrors 10, 11 for steering the coherent laser beam 12 departing the laser source 13 which comprises the laser diode 2, the cooling device 3 and the optical systems 4, 5, 6. The focussing optical system 6 may be provided for focussing the coherent beam 12 before entering the galvanometer beam deflection system 7, or after the beam has departed the galvanometer beam deflection system 7. The former is shown in the embodiment of FIG. 2 in which the focussing optical system 6 is constituted by a movable objective lens, for example a zoom lens, movable to alter the focussing, and therefore the spot size, of the emergent coherent laser beam 12.

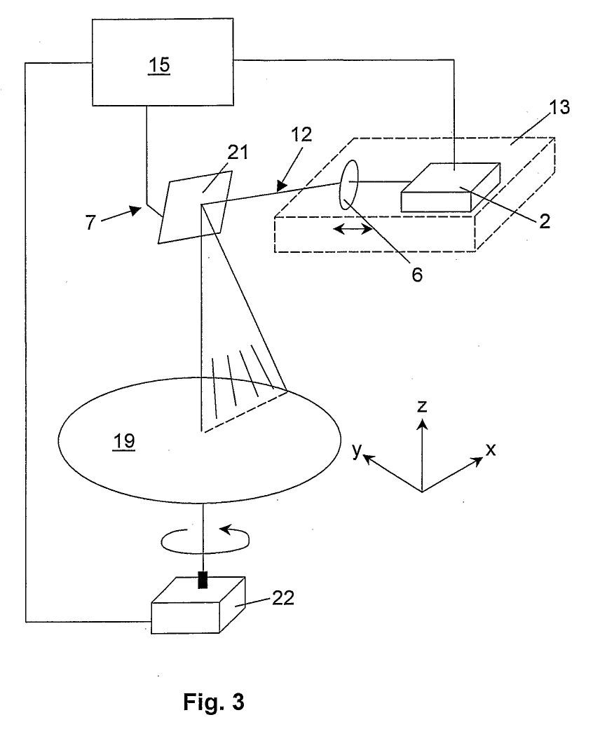

The galvanometer beam deflection system 7 is controlled by a scanner control electronics module 14 which receives input from a central control system 15. The central control system 15 receives input from a human machine interface 16 which may be a keyboard, personal computer, or the like; signals from product sensors 17, such as manually operated pulse generators or switches; or external control systems. The central control system 15 may also receive input from a substrate motion system 18 for moving the substrate 19 itself. The substrate motion system 18 may take the form of a device 22 for rotating the substrate 19 as shown in FIG. 3, or a motion system for controlling movement of a substrate table or conveyor in a direction perpendicular to a single mirror galvanometer scanning direction. A power supply unit 20 supplies power to the laser diode 2, the control system 15, and the scanner control electronics module 14 for controlling the galvanometer beam deflection system 7. The dual axis galvanometer beam deflector system 7 may be used in conjunction with the substrate motion system 18, configured such that movement in one or both axes of the galvanometer is controlled to compensate for movement of the substrate motion system 18.

Operation of the exemplary system of FIGS. 1 and 2 will now be described. A substrate 19 including an additive susceptible to changing colour is provided on a fixed, or movable, support structure. Where a galvanometer system 7 comprising a single mirror is provided for scanning the laser beam in one direction (X or Y) then the substrate 19 is provided on a movable support for traversing the substrate 19 in a direction perpendicular to the scanning direction of the galvanometer 7. The substrate motion system 18 controls movement of the substrate. Where a dual galvanometer system comprising two galvanometer mirrors is provided, then the substrate 19 may be fixed spatially by a suitable support structure, as shown in FIG. 2. Alternatively, the substrate may move under the substrate motion system 18 as described above. The substrate 19, prior to introduction to the substrate-marking system 1, may be coated or otherwise provided with the additive susceptible to changing colour upon irradiation. Alternatively, the substrate itself may be specifically designed so as to change colour upon irradiation. Exemplary additives suitable for use with the substrate-marking system 1 of the present invention will be described hereafter.

An image to be marked on the substrate 19 is input via the human machine interface 16, or external control system 17. The image is converted into an image signal for input to the control system 15. It will be apparent to those skilled in the art that the image signal may be input by any suitable means, for example a download from a system, and the interface 16 is provided as one suitable means. The control system 15 uses the image signal to control the power supply to the laser diode 2 and the scanner control electronics module 14 for controlling the galvanometer beam deflection system 7. In this manner the laser diode 2 is controlled by the control system 15 and the power supply unit 20 to emit a pulse of laser light through the optical systems 4, 5, 6 to the galvanometer beam deflection system 7 which directs the coherent laser beam pulse 12 towards a desired point on the substrate 19. Depending on the fluence level of the incident laser beam at the desired point on the substrate 19, the additive at that point changes colour to one of a plurality of colours or shades, each different from a colour of the additive, if any, prior to the irradiation. Subsequently, a further laser beam pulse, which may be of the same or a different power level, is directed by the galvanometer beam deflection system 7 to a second desired point on the substrate 19 to effect another change in colour at the second desired point. This process may be repeated for a plurality of desired points on the substrate in order to create an intended grey scale monochrome or multi-colour image on the substrate 19. The relationship between consecutive pulses and the desired positions on the substrate is dependent on whether the system 1 operates in a progressive scan or vector format. In vector format imaging the “pulses” may be relatively long such that the laser is turned on at the start of the vector and off at the end of the vector, or potentially change the power level mid-way through the vector to change the line being marked to a different shade or colour.

Turning next to FIG. 3 there is shown an alternative beam alignment system comprising a galvanometer beam deflection system 7 including a single galvanometer mirror 21. The galvanometer mirror 21 directs the coherent laser beam pulse 12 in the X direction of the substrate 19 to be marked. The substrate 19 is rotatable about an axis Z driven by a motor 22. By rotating the substrate 19 and deflecting the beam 12 using the galvanometer mirror 21, the entire surface of the substrate 19 may be irradiated as desired to form an image thereon.

As an alternative to the embodiment shown in FIG. 3, the single mirror 21 of the galvanometer system 7 may be configured to move in only one of the X or Y directions and a substrate support structure such as a conveyor or substrate table may be moved scanwise in a direction perpendicular to the galvanometer scan direction.

Next will be described an example of a coating formulation which may be applied to the substrate 19 prior to marking with the substrate-marking apparatus of the substrate-marking system 1 of the present invention. The coating formulation comprises a solution of 10,12 pentacosadiynoic acid, Cyracure 6974 (photoacid generator), Elvacite 2028 (acrylic binder) and methyl ethyl ketone (MEK). This mixture is applied onto paper using a wire bar coater to provide an even coating of the mixture. This coating formulation is susceptible to colour change upon application of light energy in the form of laser light. A UV laser diode 2 emitting in the 400-500 nanometre range is suitable for use in the system 1 of the present invention with the above-mentioned formulation. This coating formulation is transparent and clear and when coated on paper provides a similar reflectance spectrum to that of the bare paper. The reflectance of the coated paper remains substantially unchanged after irradiation with the laser diode 2 to form an image on the substrate 19. This is particularly advantageous in that the problems of differential gloss apparent in many toner or ink based printing systems is overcome. The coating formulation described above is suitable for use with the substrate marking apparatus of the present invention operating at a constant marking speed of up to approximately 50 to 250 mm/s depending on the laser diode, the fluence control at each desired point on the substrate 19 being controlled by alteration of the output power of the laser diode 2. The above described formulation typically undergoes colour change from colourless to blue, to red, and finally to yellow by respective increases in the fluence level of the incident laser beam 12.

Next will be described a second exemplary coating formulation suitable for applying to the substrate 19 for the substrate marking system 1 of the present invention. The coating formulation comprises a solution of N-ethylcarbazole and photoacid generator Cyracure 6974 (a solution of triarylsulphonium hexafluoroantimonate in tropylene carbonate) in methyl ethyl ketone (MEK). The coating formulation is then applied to the substrate 19, e.g. paper, using a K-bar and allowed to dry thoroughly resulting in a transparent, colourless coating. The coating formulation develops blue and green colours, respectively, with increasing fluence levels upon irradiation.

The above described formulations are provided as non-limiting examples of formulations to be used on or in the substrate 19 of the substrate-marking system 1 in accordance with the present invention. Further examples are provided in Applicant's co-pending International Patent Applications Nos. PCT/GB2005/004355 and PCT/GB2005/003222. Derivations therefrom and suitable alternatives will be readily appreciated by those skilled in the art.

1-21. (canceled)

22. A substrate-marking system comprising a substrate marking apparatus and a substrate which is susceptible, or includes an additive which is susceptible, to changing colour upon irradiation, the apparatus comprising:
a laser diode for emitting a beam of laser light;
a fibre optic cable coupled to the laser for homogenizing the laser beam; and,
a galvanometer for aligning a desired point on the substrate with the homogenized laser beam such that the laser beam irradiates the desired point thus causing the additive, in use, to change colour at said point.

23. The system according to claim 22, further comprising means for modulating a power level of the laser beam irradiating said point.

24. The system according to claim 22, further comprising additional means for shaping the laser beam.

25. The system according to claim 24, wherein the beam-shaping means includes a collimating lens.

26. The system according to claim 24, wherein the beam-shaping means includes an objective, or zoom, lens.

27. The system according to claim 26, wherein the objective lens is movable to alter a focal length or spot size of the laser beam.

28. The system according to claim 22, wherein the galvanometer is driven by a control system operating in a vectoring mode.

29. The system according to claim 22, wherein the galvanometer is driven by a control system operating in progressive scan mode.

30. The system according to claim 22, wherein the galvanometer comprises either a single or dual galvanometer mirrors.

31. The system according to claim 22, wherein the laser diode is an IR, VIS, or UV laser.

32. The system according to claim 22, wherein the laser diode operates at a wavelength between approximately 10 nm and 1 mm.

33. The system according to claim 22, wherein the laser diode is pulsed and operates at a frequency of between approximately 1 Hz and 1 GHz.

34. The system according to claim 22, wherein the laser has a continuous wave output and the beam of laser light emitted therefrom is gated.

35. The system according to claim 22, wherein the laser beam provides a fluence level of less than 500 mJ/cm², when in use.

36. The system according to claim 22, wherein the substrate, or additive therein, is thermally sensitive and changes colour upon application of thermal energy by the laser beam.

37. The system according to claim 36, wherein the additive, when provided, is susceptible to changing colour to one of at least two selectable colours upon irradiation, each selectable colour being different from the colour, if any, of the additive prior to irradiation such that, in use, a multi-tonal colour image can be produced on the substrate.

38. The system according to claim 22, wherein the substrate, or additive therein is susceptible to colour change upon application of light energy in the form of laser light.

39. The system according to claim 38, wherein the additive, when provided, is susceptible to changing colour to one of at least two selectable colours upon irradiation, each selectable colour being different from the colour, if any, of the additive prior to irradiation such that, in use, a multi-tonal colour image can be produced on the substrate.

40. The system according to claim 22, wherein the substrate material is selected from metals, alloys, glasses, ceramics, plastics, fabrics, wood, paper, card, resins, rubbers, foams, composites, stone and edibles.

41. A method of substrate-marking using a substrate-marking system comprising a substrate marking apparatus and a substrate which is susceptible, or includes an additive which is susceptible, to changing colour upon irradiation, the apparatus comprising:
a laser diode for emitting a beam of laser light;
a fibre optic cable coupled to the laser for homogenizing the laser beam; and,
a galvanometer for aligning a desired point on the substrate with the homogenized laser beam such that the laser beam irradiates the desired point thus causing the additive, in use, to change colour at said point;
wherein said method comprises the steps of:
a) controlling the galvanometer to align a desired point on the substrate with the laser beam emitted by the laser diode and homogenized by the fibre optic cable coupled thereto; and,
b) irradiating the desired point with the laser beam to cause the substrate, or additive, to change colour at said point.

42. The method according to claim 41, further comprising repeating steps a) and b) for a plurality of desired points to produce either a greyscale monochrome or a multi-tonal colour image on the substrate.
